(19) United States
(12) Patent Application Publication
(10) Pub. No.: US 2026/0073539 A1
(43) Pub. Date: Mar. 12, 2026

(54) APPARATUS AND METHOD FOR CAMERA-BASED OBJECT DISTANCE ESTIMATION

(71) Applicants: INDUSTRIAL COOPERATION FOUNDATION JEONBUK NATIONAL UNIVERSITY, Jeonju-si (KR); DY INNOVATE Corporation, Iksan-si (KR)

(72) Inventors: Sang Jun Lee, Jeonju-si (KR); Gyu Tae Hwang, Iksan-si (KR); Ji Min Song, Mokpo-si (KR); Ji Ho Choi, Jeonju-si (KR); Kyung Min Kim, Iksan-si (KR); Min Ji Hong, Iksan-si (KR); So Yeon Jin, Jeonju-si (KR)

(73) Assignees: INDUSTRIAL COOPERATION FOUNDATION JEONBUK NATIONAL UNIVERSITY, Jeonju-si (KR); DY INNOVATE Corporation, Iksan-si (KR)

(21) Appl. No.: 19/323,675

(22) Filed: Sep. 9, 2025

(30) Foreign Application Priority Data
Sep. 10, 2024 (KR) 10-2024-0123143

(51) Int. Cl. G06T 7/521; G01S 7/48; G01S 17/42; G06V 10/80; G06V 20/58

(52) U.S. Cl. CPC G06T 7/521; G01S 7/4808; G01S 17/42; G06V 10/803; G06V 20/58; G06T 2207/20081; G06T 2207/30261

(57) ABSTRACT

The present disclosure relates to an apparatus and method for estimating a distance to an object. More particularly, the apparatus includes a camera for capturing surrounding images, a LiDAR for generating a projection image by analyzing surrounding three-dimensional spatial positions, an object detection model for detecting objects in the images, a depth estimation model for estimating distances to the objects, a training unit for training the object detection model and the depth estimation model, and an estimation unit for detecting the objects in the images and estimating the distances to the objects using the object detection model and the depth estimation model. The apparatus and method may detect objects and estimate distances to the objects by using only a single camera image.

### CROSS-REFERENCE TO RELATED APPLICATION

This application claims the benefit under 35 U.S.C. § 119 of Korean Patent Application No. 10-2024-0123143 filed on Sep. 10, 2024, in the Korean Intellectual Property Office, the entire disclosure of which is incorporated herein by reference for all purposes.

### BACKGROUND

### 1. Field

The present disclosure relates to a method and apparatus for estimating a distance to an object, and more particularly, to a method and apparatus for performing camera-based object detection and distance estimation by using an object detection model and a distance estimation model.

This work was conducted under the project entitled Regional Intelligence Innovation Talent Development (Korean original name: [symbol] funded by the Ministry of Science and ICT in 2025 through support from the Institute of Information & Communications Technology Planning & Evaluation (IITP) (Project No. IITP-2025-RS-2024-00439292).

### 2. Description of Related Art

The Republic of Korea, along with Japan and the United States, has entered a super-aged society in which more than 21% of the population is aged 65 or older. As a result, demand for unmanned vehicles has been increasing across various industries, and research and development is underway to enhance the safety of autonomous driving.

Such unmanned vehicles are equipped with driving systems based on GPS or magnetic guidance sensors and are generally provided with collision-avoidance systems based on ultrasonic sensors or magnetic sensors to prevent collisions with obstacles.

However, as unmanned vehicles incorporate multiple sensors, costs rise sharply, maintenance becomes difficult, and available functions and services are limited because each sensor supports different capabilities.

To address these issues, approaches using cameras and LiDAR have been proposed to perform operations such as forward monitoring, object tracking, distance detection, and emergency control.

In particular, deep learning technologies based on detection data from cameras and LiDAR are attracting significant attention. For example, objects may be detected through a camera, the distance to the objects may be calculated using LiDAR sensing data, and the calculated distance may then be fused with the camera image to perform forward monitoring, object tracking, distance detection, and emergency control.

However, conventional deep learning approaches based on camera and LiDAR detection data require large training datasets and extensive training time. In addition, LiDAR sensor signals have low density and a smaller field of view (FoV) than cameras, making it difficult to estimate depth at the upper and lower regions of an image, which can lead to corner cases.

Related prior art includes Korean Patent Application Publication No. 10-2023-0081807 (published Jun. 8, 2023), Korean Patent Application Publication No. 10-2022-0094813 (published Jul. 6, 2022), and Korean Patent Application Publication No. 10-2021-0017525 (published Feb. 17, 2021).

### SUMMARY

To achieve the above objective, an apparatus for estimating a distance to an object according to an embodiment of the present disclosure may include: a camera configured to capture an image; a LIDAR configured to generate a projection image by analyzing three-dimensional spatial positions; an object detection model configured to detect an object in the image; a depth estimation model configured to estimate a distance to the object; a training unit configured to train the object detection model and the depth estimation model; and an estimation unit configured to detect the object in the image and to estimate the distance to the object by using the object detection model and the depth estimation model. The depth estimation model is trained by using both the projection image and the image. Once training is complete, the depth estimation model estimates depth using only the image.

The training unit may train the object detection model using an iterative learning technique based on pseudo-labels.

The training unit may include a fusion unit configured to combine the image and the projection image. The fusion unit may include: a matching unit configured to indicate the object detected by the object detection model with coordinates of a bounding box for a corresponding object in the projection image; an ordering unit configured to determine an order of the objects based on distances from the camera; a masking unit configured to mask, with a value of zero, an overlapping region occurring between the objects; and a mapping unit configured to perform LiDAR mapping for the respective objects.

The fusion unit may be configured to project three-dimensional coordinates of the projection image onto two-dimensional coordinates of the image using a Euclidean transformation.

The apparatus for estimating a distance to an object may further include an operation unit configured to stop movement or provide a warning when the object is determined to be within a preset distance based on an estimation result of the estimation unit.

In another aspect, a method for estimating a distance to an object according to an embodiment of the present disclosure includes: capturing an image using a camera; generating a projection image using a LIDAR; training, by a training unit, an object detection model using the image; training, by the training unit, a depth estimation model using the image, the projection image, and an object detected by the object detection model; and calculating, by an estimation unit, a distance to the object included in the image by applying only the image to the object detection model and the depth estimation model.

The training of the object detection model may include performing training of the object detection model using an iterative learning technique based on pseudo-labels.

The training of the depth estimation model may include: transforming the three-dimensional projection image into a two-dimensional coordinate system; indicating the object detected by the object detection model with coordinates of a bounding box corresponding to an object in the projection image; determining an order of the objects according to distances from the camera; masking, with a value of zero, an overlapped region occurring between the objects for an object farther from the camera; performing LIDAR mapping for the respective objects; and training the depth estimation model using information of the depth and the image.

The transforming may include projecting three-dimensional coordinates of the projection image onto two-dimensional coordinates of the image using a Euclidean transformation.

The method for estimating a distance to an object may further include: after the calculating of the distance to the object, stopping movement of a device equipped with the camera or providing a warning, by an operation unit, when the object is determined to be within a preset distance.

### BRIEF DESCRIPTION OF THE DRAWINGS

FIG. 1 is a diagram illustrating a training process of an apparatus for estimating a distance to an object according to an embodiment of the present disclosure.

FIG. 2 is a diagram illustrating a continual learning process of the apparatus for estimating a distance to an object according to an embodiment of the present disclosure.

FIG. 3 is a diagram illustrating an operation of a fusion unit of an apparatus for estimating a distance to an object according to an embodiment of the present disclosure.

FIG. 4 is a diagram illustrating a process of estimating a distance to an object by the distance estimation apparatus according to an embodiment of the present disclosure.

FIG. 5 is a flowchart illustrating a training process of a method for estimating a distance to an object according to an embodiment of the present disclosure.

FIG. 6 is a flowchart illustrating a process of projecting a recognized object onto LIDAR and performing mapping according to an embodiment of the present disclosure.

FIG. 7 is a flowchart illustrating a method of estimating a distance to an object by a distance estimation apparatus according to an embodiment of the present disclosure.

### DETAILED DESCRIPTION

The present disclosure may be implemented in various forms and embodiments. Certain embodiments are illustrated in the drawings and described in detail below.

These embodiments are provided by way of example only and are not intended to limit the disclosure. It should be understood that the disclosure encompasses all modifications, equivalents, and alternatives falling within its spirit and scope.

The terminology used herein is for the purpose of describing particular embodiments only and is not intended to limit the disclosure. Unless the context clearly indicates otherwise, the singular includes the plural. As used herein, the terms, such as “comprise”, “include” and “have,” and variations thereof, indicate the presence of specified features, steps, operations, elements, or combinations thereof, but do not preclude the presence or addition of other features, steps, operations, elements, or combinations thereof.

Unless otherwise defined, all technical and scientific terms used herein have the same meaning as commonly understood by those of ordinary skill in the art to which the disclosure pertains. Terms defined in general dictionaries are to be interpreted consistently with their usage in the relevant technical field, and unless expressly defined herein, should not be construed in an idealized or overly formal sense.

The present disclosure aims to address the above technical problems and to provide an apparatus for estimating a distance to an object (hereinafter, also referred to as “distance estimation apparatus”) and a method for estimating a distance to an object (hereinafter, also referred to as “distance estimation method”), which are configured to estimate objects and distances in an image captured by a single camera.

In another aspect, the present disclosure aims to provide the distance estimation apparatus and method thereof, which perform deep learning for object recognition and distance estimation under conditions of a limited amount of training data.

Preferred embodiments of the disclosure will now be described in detail with reference to the accompanying drawings. In the drawings, like reference numerals designate like elements, and redundant descriptions of the same elements will be omitted for clarity.

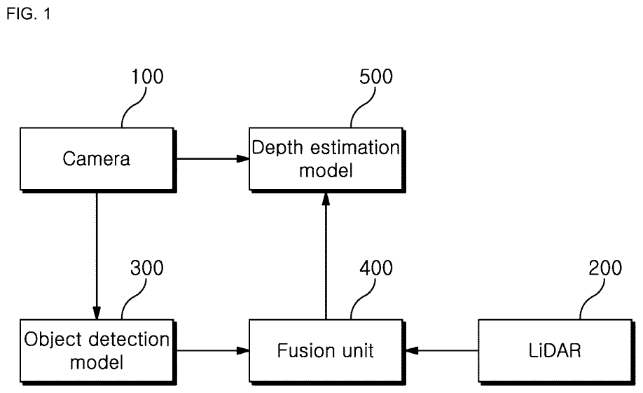

FIG. 1 is a diagram illustrating a training process of an apparatus for estimating a distance to an object according to an embodiment of the present disclosure.

The apparatus for estimating a distance to an object according to an embodiment of the present disclosure may include a camera 100, a LIDAR 200, an object detection model 300, a fusion unit 400, a depth estimation model 500, and a verification unit (not shown).

The camera 100 may be a commonly used digital camera configured to capture images in predetermined frame units.

In one embodiment, all operations may be performed using only a single camera, and thus, in the following description, the camera 100 may refer to a single camera.

The LiDAR 200 may emit laser pulses and measure the return time thereof to analyze the three-dimensional spatial positions of reflection points.

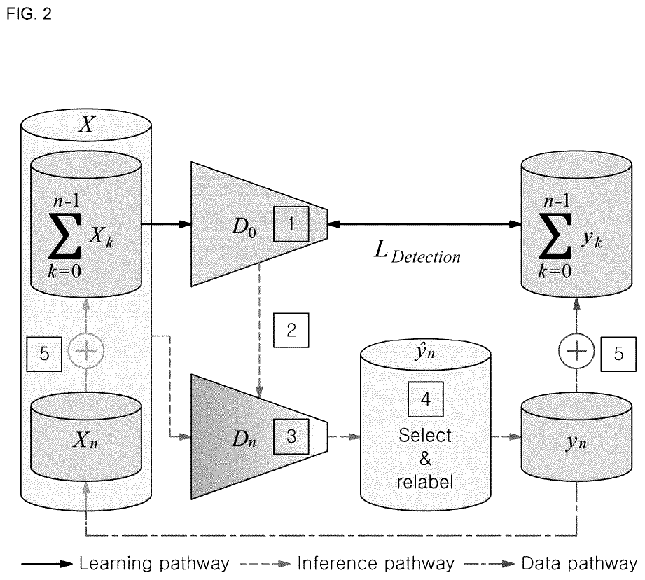

The object detection model 300 may detect an object included in an image captured by the camera 100 and may be trained by using a continual learning technique, details of which will be described in connection with FIG. 2.

The object detection model 300 may employ a YOLOv5 model, which is a widely used YOLO (You Only Look Once) series model with high inference accuracy, including a backbone network for feature extraction, a neck network for feature fusion across layers, and a head for estimating bounding box coordinates and classes.

The backbone network may be CSP-DarkNet (Cross Stage Partial-DarkNet), which can reduce computational load while maintaining accuracy by distributing portions of feature maps during convolution.

The network may apply a path aggregation network (PAN), which focuses on lower-level features, among feature pyramid networks (FPNs) that fuse multi-scale feature maps, and the head may be implemented as convolutional layers configured to estimate bounding box parameters and class probabilities from feature maps output by the neck network.

In particular, the objects in an embodiment of the disclosure may include two or more classes, such as persons and vehicles. Accordingly, a small and fast YOLOv5s model may be used; however, the disclosure is not limited thereto, and any model capable of detecting objects may be employed without limitation.

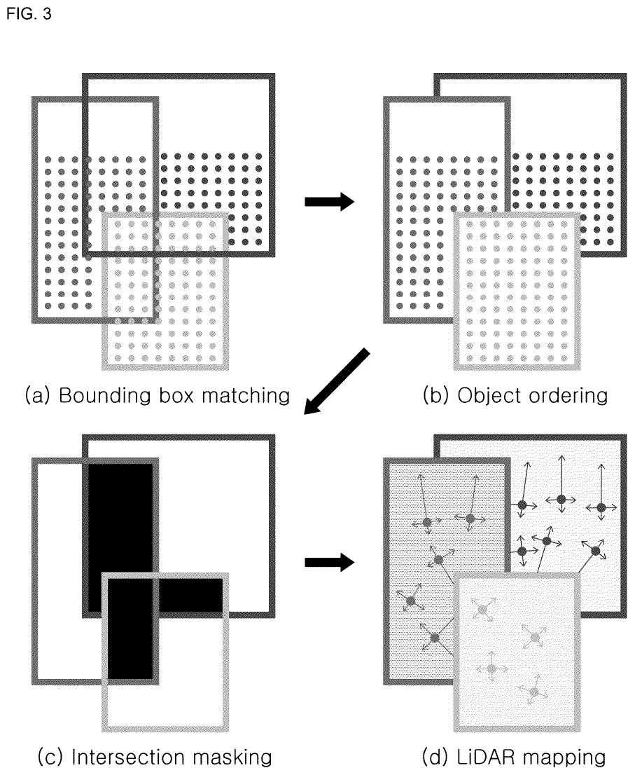

The fusion unit 400 may operate by mapping regions outside the field of view (FoV) of the LiDAR 200 under the assumption that depth information within a bounding box based on the image captured by the camera 100 and object information estimated by the object detection model 300 is similar. In this manner, distance loss for each object may be minimized, and the fusion unit 400 may be used to train the depth estimation model 500. The operation of the fusion unit 400 will be described in detail with reference to FIG. 3.

The depth estimation model 500 may be trained using images captured by the camera 100 and data from the fusion unit 400, and once training is completed, the depth estimation model 500 may estimate the depth of an object within an image using only the image, without requiring LiDAR 200 data.

Specifically, when an image captured by the camera 100 is input, the depth estimation model 500 may estimate the depth of an object included in the image and may be trained by comparing the depth estimation result with the result from the fusion unit 400 to reduce errors. Since the depth estimation model 500 first estimates depth using only the image captured by the camera 100 and then is trained to minimize errors with respect to the fusion unit 400 generated using LiDAR 200, it follows that the trained depth estimation model 500 can estimate a distance to an object within an image using only the image captured by the camera 100.

The depth estimation model 500 may have an encoder-decoder structure in which the encoder includes a feature extractor and atrous spatial pyramid pooling (ASPP), and the decoder includes upsampling layers and local planar guidance (LPG) layers. Intermediate feature maps output by the feature extractor of the encoder may be connected via skip connections to corresponding features of the decoder to deliver lower-level features, and the final output of the feature extractor may be processed by ASPP to enlarge the receptive field and to learn fine-grained features through convolution with multi-scale kernels. In each layer of the decoder, upsampling, skip connections, and LPG layers may be fused for each feature-map scale, and in particular, the LPG layers may allow more detailed learning as the feature maps become more fine-grained.

In addition, in an embodiment of the present disclosure, the camera 100 and the LIDAR 200 may be provided on a mobile apparatus (e.g., drone, automobile, bicycle, or golf cart) to capture surrounding environments, and a dataset for training the object detection model 300 and the depth estimation model 500 may be generated based on the data captured by the camera 100 and the LiDAR 200.

The verification unit (not shown) may verify the completion of training of the object detection model 300 and the depth estimation model 500 using a loss function.

Since the object detection model 300 and the depth estimation model 500 are trained with different learning methods, the verification unit (not shown) may calculate different loss functions for each. For example, a loss function (Ldetection) of the object detection model 300 may be calculated as Ldetection=Lreg+Lconf+Lda, where Lreg is the squared error of the center coordinates, width, and height of predicted bounding boxes at all grid cells relative to labels, and Lconf and Lda are loss functions for probabilities that each grid cell belongs to a class or that a class exists.

A loss function of the depth estimation model 500 may be calculated as shown in Equation (1) below, where gᵢ denotes log \hat{d}ᵢ-log dᵢ, T denotes the number of LiDAR points, and λ and a denote constants obtained experimentally.

$$\text{?} = \text{?} \sqrt{\frac{1}{T} \text{?} - ( \frac{1}{T} \text{?} + ( 1 - λ ) ( \frac{1}{T} \text{?}} \qquad Equation 1$$

$$\text{?} \text{indicates text missing or illegible when filed}$$

FIG. 2 is a diagram illustrating a continual learning process of the apparatus for estimating a distance to an object according to an embodiment of the present disclosure. In this embodiment, the object detection model may be trained using a repetitive learning technique based on pseudo-labels.

Referring to FIG. 2, n is a natural number representing the number of training iterations, X denotes the entire image dataset captured by the camera 100, Xₙ denotes an n^{th} subset of input data, [symbol] denotes an n^{th} prediction result, yₙ denotes an n^{th} pseudo-label, and Dₙ denotes an n^{th} trained model.

When training begins, in the first stage, an initial object detection model D₀ may be trained using subsets of X and pseudo-labels. In the second stage, parameters of the n^{th} trained initial model are transferred to Dₙ, and in the third stage, Dₙ may be used to infer all [symbol] from X. In the fourth stage, a pseudo-label yₙ may be obtained by selecting detection results and adjusting bounding boxes of [symbol] . Finally, in the fifth stage, yₙ and the corresponding Xₙ may be merged into previously constructed subsets of data to train Dₙ₊₁. In one embodiment, the initial object detection model D₀ may be constructed by applying transfer learning parameters trained on a conventional dataset such as the Microsoft COCO dataset.

In FIG. 2, solid arrows represent a learning pathway, dashed arrows represent an inference pathway, and dash-dotted arrows represent a data pathway. Although n was set to three iterations in this embodiment, the number of iterations is not limited thereto and may be increased as needed. The trained object detection model may then be used to infer objects in images captured by the camera 100.

A corner case generally refers to an unusual situation that occurs under extreme algorithmic or boundary conditions during program execution. In an embodiment of the present disclosure, however, a corner case may refer to an object that is normally located within the FoV of the camera 100 but is partially overlapped with another object in the FoV of the LiDAR 200 or only partially located within the LiDAR FoV, thereby resulting in only a portion of the object being detected.

Such corner cases may occur because the vertical FOV of the camera 100 is typically larger than that of the LiDAR 200. Accordingly, an object located within the FoV of the camera 100 may not be located within the FoV of the LiDAR 200, or may only partially fall within the LiDAR FoV. As a result, in conventional distance measurement apparatuses that employ both a camera and LiDAR, corner cases may occur in which distance information of objects located outside the FoV of the LiDAR 200 (e.g., at the upper and lower ends of the FoV of the camera 100) cannot be obtained.

In order to address corner cases arising from a mismatch between the FoV of the camera 100 and the FoV of the LiDAR 200, the fusion unit 400 may include an algorithm referred to as Object-Aware LiDAR Projection (OALP). FIG. 3 is a diagram illustrating the OALP algorithm of an apparatus for estimating a distance to an object according to an embodiment of the present disclosure. However, the disclosure is not limited thereto, and any method may be employed as long as recognized objects can be mapped onto LiDAR images and utilized as training data for the depth estimation model.

The OALP algorithm operates by mapping missing depth labels within a bounding box to the nearest LiDAR point values so as to improve distance estimation performance for objects overlapping the FoV of the LiDAR 200. The OALP may include bounding box matching, object ordering, intersection masking, and LiDAR mapping.

In bounding box matching, the object detection model 300 infers all objects included in an image, and the positions of the detected objects are displayed as bounding box coordinates on a sparse LiDAR projection image.

Since the image captured by the camera 100 is two-dimensional, whereas the LiDAR projection image is three-dimensional, bounding box matching may not be precise. To address this issue, the LiDAR 200 projection image may be converted into a two-dimensional coordinate system in one embodiment of the present disclosure.

To convert the LiDAR 200 projection image into a two-dimensional projection image, a transformation matrix [R|t] representing the relative Euclidean transformation between the camera 100 and the LiDAR 200 may be calculated, and the three-dimensional observation coordinates (P) of the LiDAR 200 may be projected onto corresponding two-dimensional coordinates (p) of the camera 100 image using Equation 2 below, where K denotes camera intrinsic parameters.

$$p = K [ R \vert t ] P \qquad Equation 2$$

Once bounding box matching is complete, object ordering may be performed, in which objects in the image are assumed to be in contact with the ground and are ordered based on the coordinates of bounding boxes contacting the ground, in accordance with their proximity to the camera.

After object ordering is complete, intersection masking may be performed for overlapping regions. Specifically, to map LiDAR points of nearer objects to occluded regions caused by overlap, the overlapping regions of bounding boxes of farther objects may be masked to a value of zero.

Once intersection masking is complete, LiDAR mapping may be performed. In this step, missing pixels for each object may be filled by applying a nearest neighbor search technique to map LiDAR points.

As such, by executing the OALP process in the fusion unit 400, recognized objects and LiDAR images may be combined, thereby converting sparse depth information into labels containing dense depth information, as shown in FIG. 3.

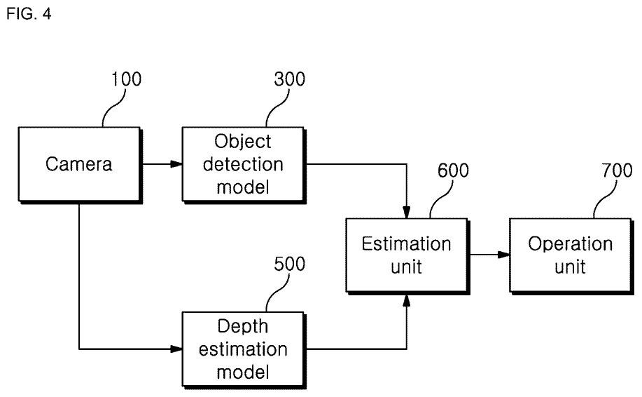

FIG. 4 is a diagram illustrating a process of estimating a distance to an object by the distance estimation apparatus according to an embodiment of the present disclosure.

An image captured by the camera 100 may be provided to the object detection model 300 and the depth estimation model 500.

The object detection model 300 may detect information of objects included in the image, and the depth estimation model 500 may estimate depth information of the objects.

An estimation unit 600 may combine the object information detected by the object detection model 300 with the depth information estimated by the depth estimation model 500, and may estimate a distance between the camera 100 and each object included in the image captured by the camera 100, and provide the estimated distances to a user.

Based on the distance information estimated by the estimation unit 600, an operation unit 700 may determine that a risk of collision exists if the distance to an object is equal to or less than a preset threshold, and may either stop movement of the apparatus equipped with the camera 100 or issue a warning to the user through visual or auditory means such as a message, light emission, vibration, or sound.

As shown in FIGS. 1 to 3, in the apparatus for estimating a distance to an object according to an embodiment of the present disclosure, the depth estimation model 500 is trained using both the camera images and the LiDAR projection images. However, once training is complete, the depth estimation model 500 may estimate a distance to an object using only the camera images without the LiDAR projection images, thereby overcoming the corner case problem of the related art.

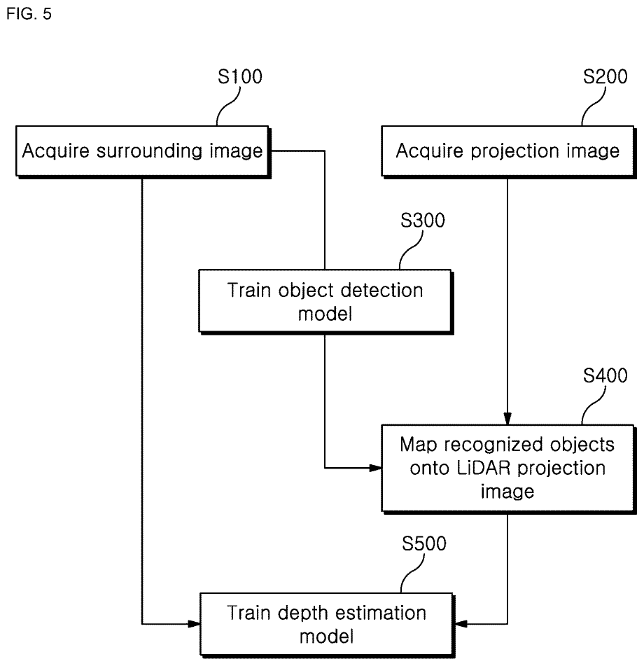

FIG. 5 is a flowchart illustrating a training process of a distance estimation method according to an embodiment of the present disclosure.

An image of a surrounding environment may be acquired using the camera 100 (S100).

In addition, a projection image may be acquired using the LiDAR 200 such that the projection image has the same center point as the image captured by the camera 100 (S200).

The image and the projection image may be captured at the same location with respect to the same center point, and the Field of View (FoV) of the camera 100 and the FoV of the LiDAR 200 may differ from each other.

The object detection model 300 is a neural network model for detecting objects included in the image acquired by the camera 100, and may be trained using a continual learning technique (S300).

Since the training method of the object detection model 300 has already been described in detail with reference to FIG. 2, a further description thereof will be omitted herein.

Once training of the object detection model 300 is completed, objects recognized by the object detection model 300 may be projected and mapped onto the LiDAR 200 for training of the depth estimation model 500 (S400).

The fusion unit 400 may map regions outside the FoV of the LiDAR 200 by applying an OALP algorithm, under an assumption that depth information inside a bounding box is similar, based on object information detected by the object detection model 300 using the image captured by the camera 100.

After mapping is completed by the fusion unit 400, the depth estimation model 500 may be trained using the image captured by the camera 100 and the data from the fusion unit 400 (S500).

In training the depth estimation model 500, when an image from the camera 100 is input, the depth estimation model 500 may estimate a distance to an object in the image, compare the estimation result with the fusion unit 400 serving as ground truth (GT), calculate an error (loss), and iteratively perform training to reduce the error.

The depth estimation model 500 may be trained iteratively with multiple datasets to reduce errors, and upon completion of training, may estimate a distance to an object located in an image using only the image captured by the camera 100, without relying on data from the fusion unit 400 based on the LiDAR 200.

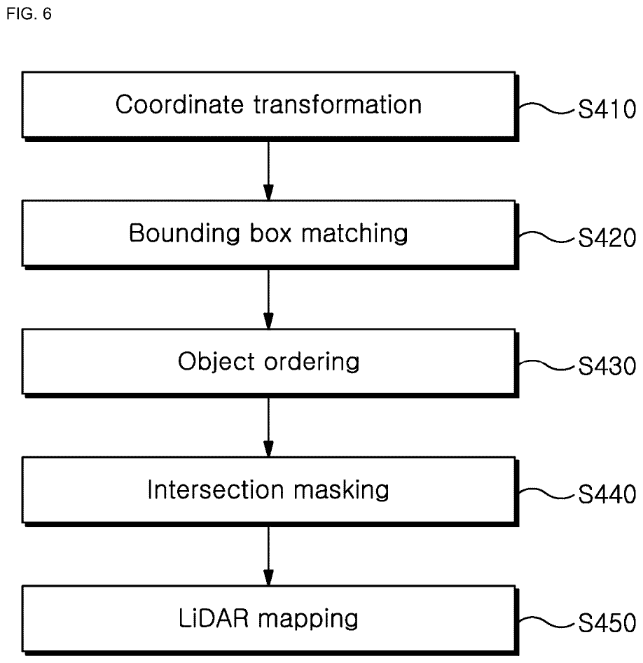

FIG. 6 is a flowchart detailing step S400 of projecting and mapping recognized objects onto the LiDAR according to an embodiment of the present disclosure.

Because a projection image of the LiDAR 200 has three-dimensional coordinates while an image captured by the camera 100 has two-dimensional coordinates, the three-dimensional coordinates of the projection image may be transformed into two-dimensional coordinates through a transformation matrix representing a Euclidean transformation relationship, in order to enable matching between the projection image and the image (S410).

After the coordinate transformation is completed, the object detection model 300 may infer all objects included in the image, and the positions of the detected objects may be indicated on a sparse LiDAR projection image using bounding box coordinates (S420).

Once the objects have been indicated, object ordering may be performed by assuming that the objects in the image are in contact with the ground, and by designating their order according to their distance from the camera based on the coordinates of bounding boxes that touch the ground (S430).

Once object ordering is completed, overlapping regions may occur due to short distances between objects. For such overlapping regions, intersection masking may be performed by masking overlapped areas of bounding boxes of farther objects with a value of zero, in order to map LiDAR points of nearer objects (S440).

After masking is completed, LiDAR mapping may finally be performed, in which LiDAR mapping is carried out by applying a nearest neighbor search technique to empty pixels for each object (S450).

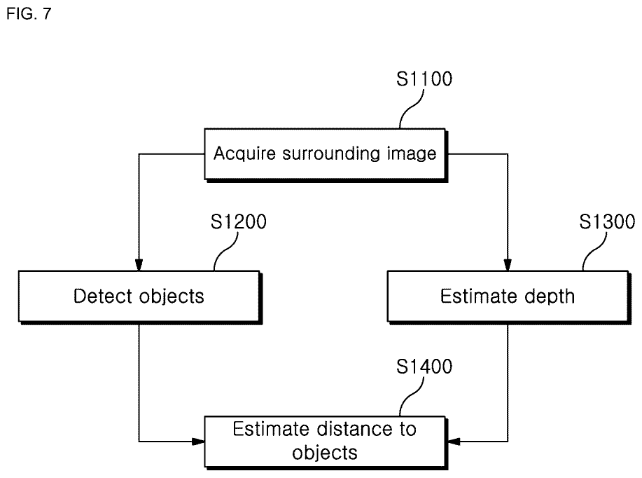

FIG. 7 is a flowchart illustrating a method of estimating a distance to an object by a distance estimation apparatus according to an embodiment of the present disclosure.

An image of the surroundings may be acquired using the camera 100 (S1100).

The object detection model 300 may receive the surrounding image and detect objects included in the image (S1200).

The depth estimation model 500 may receive the surrounding image and estimate a distance to an object within the image (S1300).

The estimation unit 600 may calculate a distance to an object by aligning object information detected by the object detection model 300 with the distance estimated by the depth estimation model 500 (S1400).

Although not illustrated in the drawings, the operation unit 700 may determine that there is a risk of collision when the distance to an object estimated by the estimation unit 600 is less than or equal to a preset threshold distance, and may either stop movement of the apparatus equipped with the camera 100 or provide a warning to the user through visual or auditory means such as a message, light emission, vibration, or sound.

As described above, the apparatus and method for estimating a distance to an object according to an embodiment of the present disclosure may detect objects and estimate the distances to the objects by using an image captured by a single camera.

In addition, by performing iterative learning, accurate object detection may be achieved even with a small amount of data, and improved performance may be provided in corner cases.

Moreover, high object detection performance may be achieved with a simple configuration, thereby enabling obstacle avoidance or emergency braking.

The apparatus and method for estimating a distance to an object according to an embodiment of the present disclosure may also detect objects and estimate the distances to the objects by using an image captured by a single camera.

Furthermore, through iterative learning, accurate object detection may be accomplished with only a limited amount of data.

The apparatus and method may also deliver improved performance in corner cases.

In addition, with a simple configuration, high object detection performance may be achieved, thereby enabling obstacle avoidance or emergency braking.

The features, structures, and effects described in the foregoing embodiments are included in at least one embodiment of the present disclosure and are not necessarily limited to only one embodiment. Moreover, the features, structures, and effects illustrated in each embodiment may be combined or modified in other embodiments by those of ordinary skill in the art to which the embodiments pertain.

Accordingly, matters related to such combinations and modifications should be construed as being within the scope of the present disclosure. Although the embodiments have been described above with reference to specific examples, these are merely illustrative and are not intended to limit the present disclosure. It will be understood by those of ordinary skill in the art that various modifications and applications not exemplified herein are possible without departing from the essential characteristics of the embodiments. For example, each constituent element specifically shown in the embodiments may be implemented in a modified form, and differences related to such modifications and applications should be construed as falling within the scope of the present disclosure as defined by the appended claims.

What is claimed is:

1. An apparatus for estimating a distance to an object, comprising:
a camera configured to capture an image;
a LIDAR configured to generate a projection image by analyzing three-dimensional spatial positions;
an object detection model configured to detect an object in the image;
a depth estimation model configured to estimate a distance to the object;
a training unit configured to train the object detection model and the depth estimation model; and
an estimation unit configured to detect the object in the image and to estimate the distance to the object by using the object detection model and the depth estimation model,
wherein the depth estimation model is trained by using both the projection image and the image, and
wherein, after training is completed, the depth estimation model estimates depth using only the image.

2. The apparatus for estimating a distance to an object of claim 1,
wherein the training unit trains the object detection model using an iterative learning technique based on pseudo-labels.

3. The apparatus for estimating a distance to an object of claim 1,
wherein the training unit comprises a fusion unit configured to combine the image and the projection image,
the fusion unit comprising:
a matching unit configured to indicate the object detected by the object detection model with coordinates of a bounding box for a corresponding object in the projection image;
an ordering unit configured to determine an order of the objects based on distances from the camera;
a masking unit configured to mask, with a value of zero, an overlapping region occurring between the objects; and
a mapping unit configured to perform LiDAR mapping for the respective objects.

4. The apparatus for estimating a distance to an object of claim 3,
wherein the fusion unit is configured to project three-dimensional coordinates of the projection image onto two-dimensional coordinates of the image using a Euclidean transformation.

5. The apparatus for estimating a distance to an object of claim 1, further comprising:
an operation unit configured to stop movement or provide a warning when the object is determined to be within a preset distance based on an estimation result of the estimation unit.

6. A method for estimating a distance to an object, comprising:
capturing an image using a camera;
generating a projection image using a LIDAR;
training, by a training unit, an object detection model using the image;
training, by the training unit, a depth estimation model using the image, the projection image, and an object detected by the object detection model; and
calculating, by an estimation unit, a distance to the object included in the image by applying only the image to the object detection model and the depth estimation model.

7. The method for estimating a distance to an object of claim 6,
wherein the training of the object detection model comprises performing training of the object detection model using an iterative learning technique based on pseudo-labels.

8. The method for estimating a distance to an object of claim 6,
wherein the training of the depth estimation model comprises:
transforming the three-dimensional projection image into a two-dimensional coordinate system;
indicating the object detected by the object detection model with coordinates of a bounding box corresponding to an object in the projection image;
determining an order of the objects according to distances from the camera;
masking, with a value of zero, an overlapped region occurring between the objects for an object farther from the camera;
performing LiDAR mapping for the respective objects; and
training the depth estimation model using information of the depth and the image.

9. The method for estimating a distance to an object of claim 8,
wherein the transforming comprises projecting three-dimensional coordinates of the projection image onto two-dimensional coordinates of the image using a Euclidean transformation.

10. The method for estimating a distance to an object of claim 6, further comprising:
after the calculating of the distance to the object,
stopping movement of a device equipped with the camera or providing a warning, by an operation unit, when the object is determined to be within a preset distance.
